(19) United States
(12) Patent Application Publication
(10) Pub. No.: US 2016/0216156 A1
(43) Pub. Date: Jul. 28, 2016

(54) SYSTEM, METHOD AND APPARATUS FOR PERFORMING COLOUR MATCHING

(71) Applicants: Paul PENG, Parkville, Melbourne, Victoria (AU); Djordje DIKIC, Melbourne, Victoria (AU); Jiatian LIANG, Melbourne, Victoria (AU)

(72) Inventors: Paul Peng, Melbourne, Victoria (AU); Djordje Dikic, Melbourne, Victoria (AU); Jiatian Liang, Melbourne, Victoria (AU)

(21) Appl. No.: 15/025,743

(22) PCT Filed: Sep. 27, 2014
(86) PCT No.: PCT/AU2014/050253

§ 371 Date: Mar. 29, 2016

(30) Foreign Application Priority Data
Oct. 8, 2013 (AU) 2013903862

(51) Int. Cl. G01J 3/46; G01J 3/50; G01J 3/02

(52) U.S. Cl. CPC G01J 3/463; G01J 3/0251; G01J 3/501

(57) ABSTRACT

The present invention relates to colour sampling and in particular a system, method and apparatus for sampling the colour of a surface and electronically determining the colour of the surface. Colour sampling is a process by which the colour of a surface is matched to a known digital quantity.

### TECHNICAL FIELD

The present invention relates to colour sampling and in particular a system, method and apparatus for sampling the colour of a surface and electronically determining the colour of the surface.

### BACKGROUND OF INVENTION

Colour sampling is a process by which the colour of a surface is matched to a known digital quantity.

Conventional colour sampling arrangements sample and match colours two ways, namely; invasive and non-invasive sampling.

Invasive sampling requires a sample to be taken to an off-site lab for matching, whereas, non-invasive arrangements attempt to match the colour sample (on a wall for example) by directly sampling the surface on-site. A problem with invasive sampling is that while it is highly accurate and relatively inexpensive for end-users, it requires a sample to be taken to an off-site lab for testing which results in destructive interference with the surface since a sample must be removed. While non-invasive sampling directly matches a sample surface to a stored colour database or values without destructively interfering with the sample, it is expensive and also typically associated with proprietary colour databases which, restricts its use from the general public.

It would therefore be desirable to provide an improved sampling system and method which ameliorates or at least alleviates one of the above problems.

A reference herein to a patent document or other matter which is given as prior art is not to be taken as an admission or a suggestion that the document or matter was known or that the information it contains was part of the common general knowledge as at the priority date of any of the claims.

### SUMMARY OF INVENTION

According to a first aspect, the present invention provides, a method of performing colour matching on light that has interacted with a surface sample, the method including the steps of: (a) receiving data from one or more light detectors relating to a surface sample; (b) normalising the data against, one or more predetermined greyscale calibration points, thereby determining the light intensity; and (c) normalising the data against a predetermined set of colour calibration points so as to provide colour corrected values.

Preferably, step (c) includes performing a matrix manipulation on the data and on a predetermined set of calibration data point so as to provide colour corrected values.

At step (b), two predetermined greyscale calibration points may be provided, the calibration points each representing known surfaces of varying intensity such that the measured data values can be interpolated or extrapolated into a straight line. This line reflects the relationship between the output of the light detector and light intensity.

The light intensity values may be adjusted based on an ambient temperature measurement.

Preferably, the matrix manipulation includes the steps of: (i) receiving the measured values of each colour; (ii) multiplying the measured values of each colour by values contained within one or more multiplier matrices (iii) summing the multiplier matrices to produce a corrected colour value.

The predetermined set of colour calibration points used to create the multiplier matrices may include one or more samples taken against known coloured surfaces. This may be performed through (i) using an optimisation process to determine a coefficient of determination (R²) value between the corrected colour values and the colour calibration points; and (ii) performing optimization on each multiplier matrix to maximise R², such that R² approaches a value of 1.0.

The colour corrected values are preferably then converted into one or more colour formats. The colour formats may include RGB, sRGB, Adobe RGB, and any other ROB representations, HSL, HSV, Hex, HSI, HLS, Va*b*, TSL and CMYK formats.

Preferably, the method further includes the step of comparing and matching the colour corrected values to one or more colour databases.

A comparison may be carried out between an underlying colour value of the sampled colour to the corresponding colour value of each colour stored in one or more databases. The colour-distance between the colours may then be calculated and the minimum colour distance between the colours is selected; thereby determining the nearest, or a number of nearest, matching colour(s) to the sample.

The colour match may then be communicated to a device such as a mobile communication device.

According to a second aspect, the present invention provides, a system, for colour sampling, the system including: a light source for illuminating a sample; a light detector operable to detect light that has illuminated the sample so as to obtain one or more measurements of the light; and a processor operable to receive and process the one or more measurements of the light so as to provide a spectral characteristic of the sample based on the measurements and determine the colour of the sample.

Preferably, the light source includes one or more LEDs and the light detector includes one or more photodiodes. The LEDs and photodiodes may be multi-colour.

Preferably, the processor is further operable to normalise the photodiodes' values against one or more calibration points.

According to a third aspect, the present invention provides, a light sampling apparatus including: an integrating sphere having at least one port; a colour sensing module disposed within the integrating sphere, the colour sensing module including at least one light source and at least one light detector; and a baffle positioned between the colour sensing module and the at least one port.

Preferably, the colour sensing module includes a front face having a first light detector which faces the baffle and a rear face having a second light detector which faces away from the baffle. The colour sensing module may include a thermometer.

Preferably, the baffle further includes a waveguide there through. The waveguide may comprise a hollow tubular ‘void’ (within the baffle itself) which allows light from the light emitters to be directed onto a sampling port. Preferably, the waveguide is of a comparable size to the light emitters.

### BRIEF DESCRIPTION OF DRAWINGS

The present invention will now be described in further detail with reference to the accompanying drawings. It is to be understood that the particularity of the drawings does not supersede the generality of the proceeding description of the invention.

FIG. 1 is a schematic diagram showing a system and method for colour matching;

FIG. 2 is a schematic diagram of a colour sensing module used in the invention;

FIGS. 3a to 3c are schematic diagrams of the integrating sphere of FIG. 2;

FIG. 4 is a schematic diagram illustrating the method of colour sensing according to the present invention; and

FIG. 5 is a flow diagram illustrating the processing of the colour sample according to the present invention.

### DETAILED DESCRIPTION

The following description describes the system in the context of a device for matching colour which may be connected to the internet and operated via a website and a server but it should be appreciated that the system can operate on a 3G or advanced mobile telephone network or the like. It will also be appreciated that the system need not operate over a network.

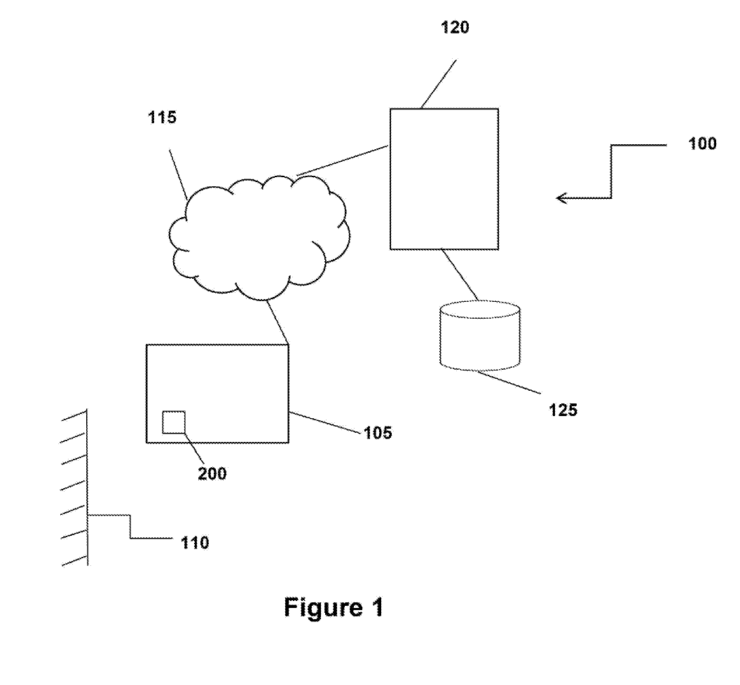

Referring to FIG. 1, there is shown an example system 100 for performing colour identification of a surface sample. The system 100 includes a colour sampler 105 which interacts with a sample 110 to determine the colour of the sample. The colour sampler 105 may be connected to a server 120 via a communications network 115 such as the internet. The server 120 includes a database 125 which stores colour information, reference information, product ID information and any other text, pictorial or numerical representation of information.

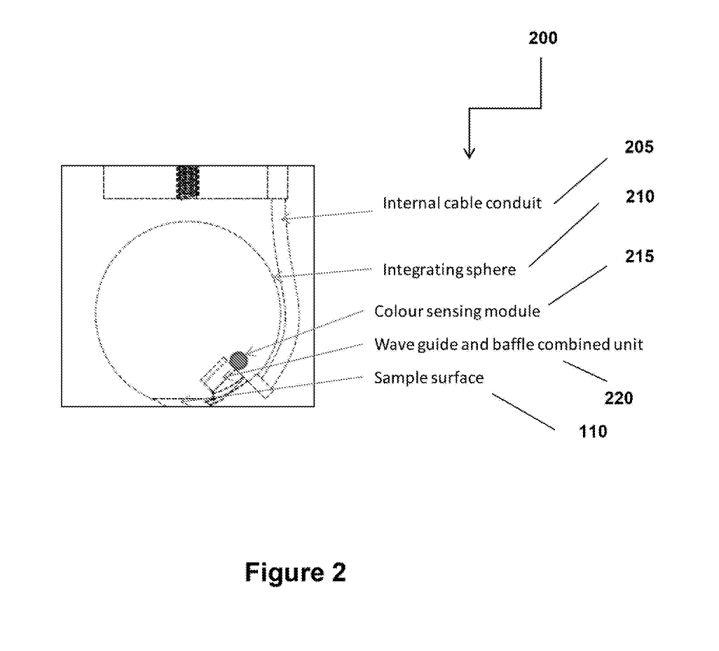

The colour sampler 105 may not be connected to a network 115 at all and may be a standalone device which has a colour matching database stored on the device itself. The colour sampler 105 may be a mobile communication device with a sampling interface 200 (described further with reference to FIG. 2) which interacts with a sample surface 110 to provide measurements of the light reflected from the sample surface 110.

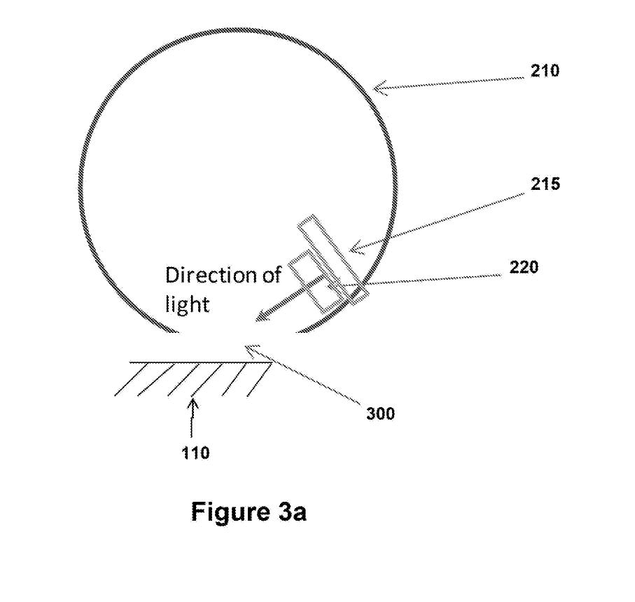

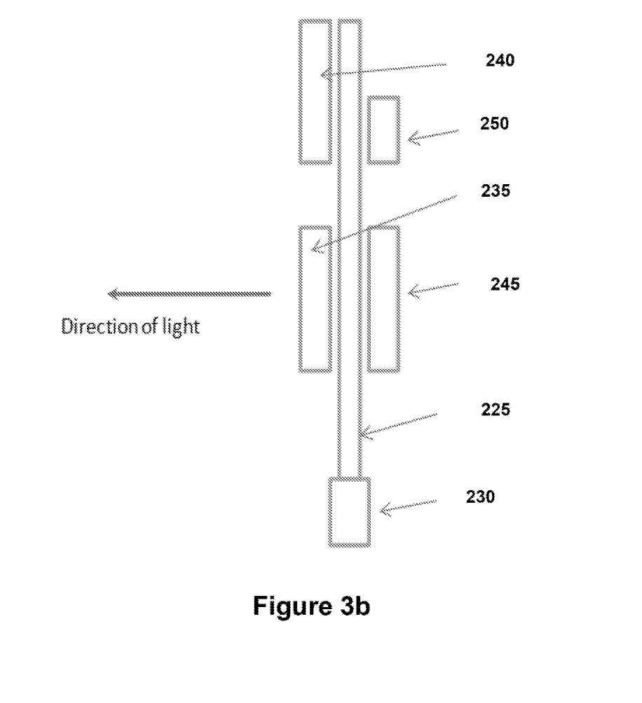

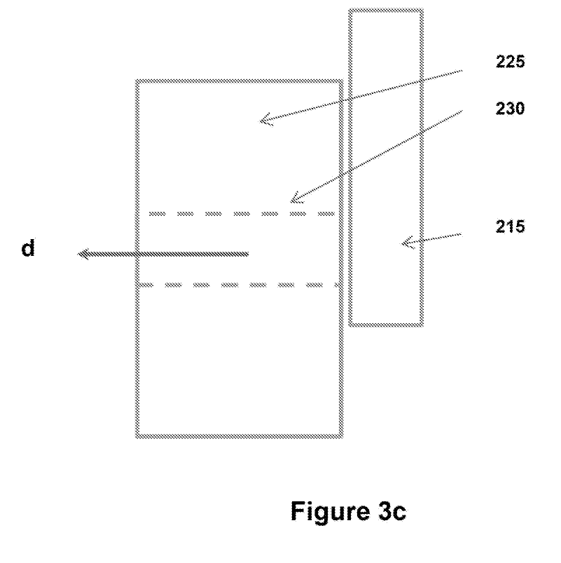

As shown in FIG. 2, the sampling interface 200 includes a waveguide and baffle unit 220 which receives the reflected light from the surface 110, a colour sensing module 215 which (a) produces the incident light, (b) determines the wavelength and intensity of the reflected light from the sample surface 110, and (c) measures the ambient temperature inside the sphere using an environment sensor and an integrating sphere 210 (which will be described further with reference to FIG. 3) and an internal cable conduit 205 for communicating the data derived from the sensing module to a processing unit [not shown]. By measuring certain characteristics of the sample surface 110, such as the wavelength and intensity of reflected light the surface's colour coordinates may be established and matched to known colour points.

FIG. 3 illustrates an integrating sphere 210 used in the sampling interface 200. The integrating sphere 210 includes a colour sensing module 215, a baffle and waveguide unit 220 and a sampling port 300. A further port (not shown) may be provided which receives power via electrical cables. The sampling port 300 allows a sampling surface 110 as shown with reference to FIG. 2 to engage with the integrating sphere 210. Advantageously the entire sampling process is enclosed in that all light emitted upon the sampling surface is contained (and detected) within the integrating sphere 210.

As shown in FIG. 3b, the colour sensing module 215 includes one or more light emitters and one or more light detectors. The light emitters and light detectors may be mounted on a printed circuit board 225 which may be attached to a connector 230 to provide power to the colour sensing module 215. The printed circuit board 225 includes a front face and a rear face, the front face facing the baffle and waveguide unit 220. On the front face, a light emitter 235 is provided. Also provided on the front face is a first light detector for sensing direct reflections of light from the sample surface 110. On the rear face of the printed circuit board 225 is a second light detector 245 which senses integrated reflections (for use within the integrating sphere—as will be described below). Also included on the rear face of the printed circuit board 225 is a thermometer 250 to measure ambient temperature.

The colour sensing module 215 illuminates the sample surface 110 via the light emitter 235 and detects the reflected light from the sample surface 110. Preferably the light emitter 235 is housed on the front face of the colour sensing module 215 so as to direct light towards the sample surface 110.

The colour sensing module may operate in two modes, namely an integrating sphere mode and a direct observation mode.

In the integrating sphere mode, which is most commonly used when sampling painted and coloured surfaces, the second light detector 245 is only engaged in order to detect light that is reflected off the wall of the integrating sphere 210.

In this mode, the integrating sphere 210 is used to spatially integrate all reflected light from the sample surface 110 thereby eliminating the effect of surface reflectivity on the output of light detector 240.

In the second mode, the apparatus may measure any surface which emits its own light, such as an LCD screen or a computer monitor for example. In this mode, only the first light detector 240 is engaged and the first light detector 240 is arranged such that it has a clear line of sight to the sample surface thereby capturing impingent light radiation directly from surface and without the need for light to be reflected within the integrating sphere 210 thereby reducing attenuation.

The printed circuit board 225 includes an upper and lower layer (upon which the light emitters, detectors and thermometers may be mounted) and a middle layer which consists of solid (un-etched) copper so as to prevent stray light from the light emitter 235 reaching the second detector unit 245. The connector 230 is advantageously placed at the base of the printed circuit board 225 so as to minimise the impact on the integrating sphere 210.

As shown in FIG. 3c, a baffle and waveguide unit 220 is provided which includes a waveguide 320 within the baffle so as to guide light in a direction of light travel “d”. Typically the baffle is a piece of opaque material placed between the first light detector 240 and the sample surface 110 in order to prevent the reflected light from reaching the first detector 240 directly. Advantageously, in the present invention, the baffle not only serves this purpose but also serves a waveguide for light from the light emitter 235. A hollow channel acting as a waveguide 320 provides a channel for light from the light emitter 235 (which is mounted on the front face of the printed circuit board 225 and faces the baffle) down to the sample surface 110. Advantageously, the presence of this hollow channel acting as a waveguide does not impede the function of the baffle but allows placement and location of all critical elements of the integrating sphere 210 to be provided within the same location which decreases light attenuation and increases performance.

The integrating sphere 210 is a hollow sphere which may have a reflective inner coating. This coating provides a non-absorbent surface from which impinging light rays may scatter elsewhere with ideally zero or close to zero loss. As such, any light within the sphere is continuously reflected until it is absorbed by detector 305 which in this case may be one or more photodiodes. Advantageously this provides spatial integration of internal light and thereby producing the same reading regardless of surface reflectivity.

The light emitter 235 may include LEDs as light sources and in particular multi-colour LEDs as the light source. The light sensors 240, 245 may include one or more photodiodes as the light sensor. Preferably the one or more photodiodes are also multi-colour.

Since the spectral responses of each colour of the LED(s) are different to each detector of the photodiode(s), this effectively achieves a similar result to having multiple separate LED colours paired with a single colour photodiode.

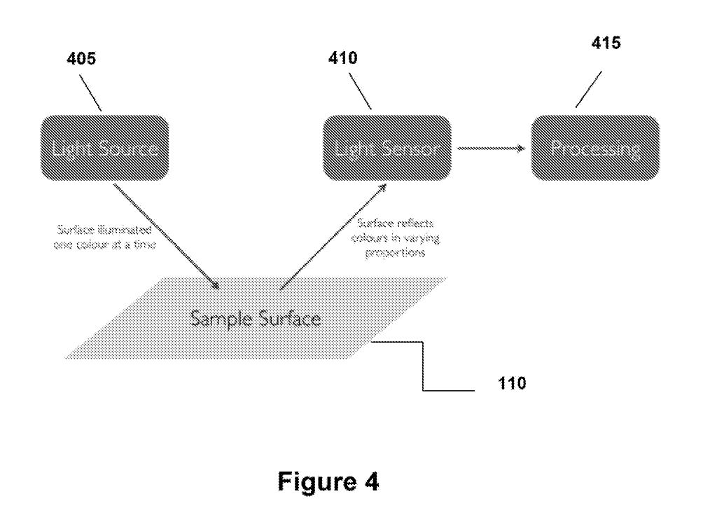

As shown in FIG. 4 in operation, each LED light colour being of single LED or a combination of LEDs is shone from the light source 405 onto the surface 110 one at a time, with one or more photodiodes in the form of a light sensor 410 simultaneously taking a reading during the ‘on’ on period of the LED output for each LED output colour). The time period for taking measurements for each LED light colour may take some time. This time period can be shorter or longer depending on the LEDs or photodiodes chosen. Once the measurements have been made, the outputs from the light sensor 410 may be encoded and forwarded to processing unit 415. Preferably the colour sensing module also includes a thermometer which measures the ambient temperature and provides data which represents temperature so as to provide grey scale correction which will be described further below.

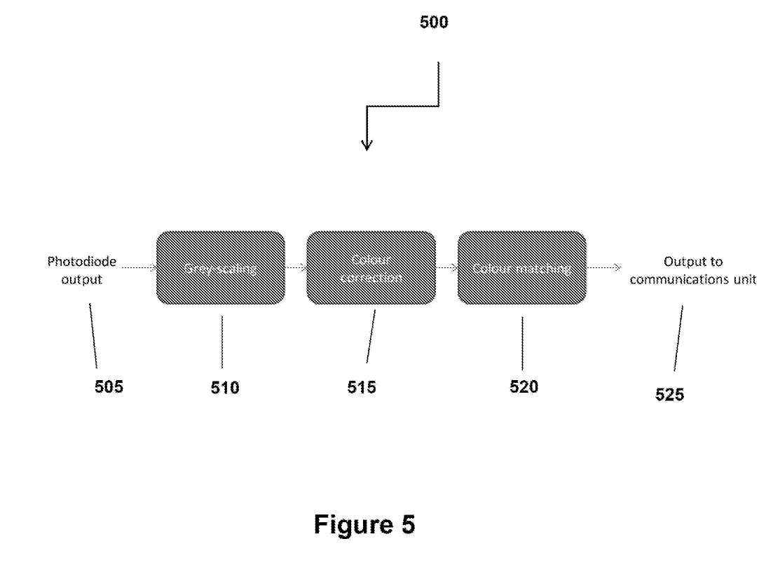

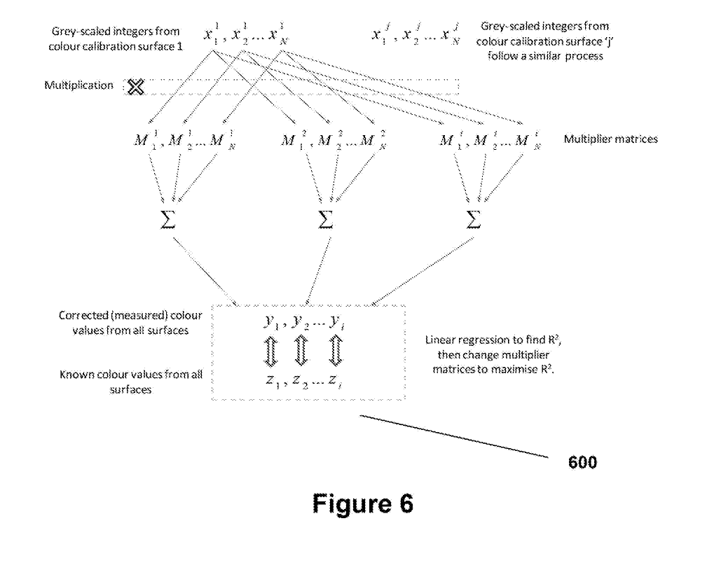

FIG. 5 illustrates the operation of the processing unit 415 shown in FIG. 4. At 505, the output from the photodiode(s) (via light sensor 410) is received by the processing unit 500. The output from the photodiode(s) is in digital integer format and is neither indicative of colour nor intensity with any accuracy. The purpose of the processing unit 415 is to convert this raw data into a format that is useful for the end user. Preferably the processing unit is maintained within a microprocessor chip and handles three functions, namely grey-scaling 510, colour correction 515 and colour matching 520.

At 510 the processor 415 performs a grey-scaling process which normalises the raw photodiode(s) values received at 505 against predetermined calibration points. The purpose of this step is to determine the intensity of the incoming light.

Preferably there are one or more stored calibration points which are measured on grey surfaces of varying intensity and whose values can then be interpolated/extrapolated into a straight line (that is, the raw photodiode(s) values have a linear relationship with the intensity of detected light) which reflects the relationship between the raw photodiode output at 505 and light intensity.

Preferably the grey-scaling calibration process (namely the stored calibration points) are predetermined during the production of the sampling interface 200 and requires no input from the end user.

In a preferred embodiment, the processing unit may also compensate for LED brightness and/or photodiode sensitivity changes with ambient temperature by adjusting the light intensity values based on the ambient temperature as may be determined by a thermometer which may be contained within the colour sensing module.

The processing unit then carries out colour correction 515 since the raw photodiode(s) output values 505 may not reflect the true colour of the surface (even after adjusting for light intensity and grey-scaling at 510). The colour correction is carried out by a matrix manipulation of the incoming colour values against one or more multiplier matrices.

The stored set of multiplier matrices are derived from one or more calibration points measured against known colour surfaces. These known coloured surfaces may be selected in such a way as to represent a colour universe which is as large and diverse as possible.

The measured values of each calibration surface are each multiplied by values contained within one or more multiplier matrices. Each multiplicative process produces values for each multiplier matrix, which are then summed to produce corrected colour values.

The stored process is repeated for each colour calibration surface and therefore produces an array of output values.

A calculation 600 is performed to find a coefficient of determination (R²) value between the array containing measured values and an array with the known surface values. An iterative optimisation process is then run on each multiplier matrix to maximise R².

Once the optimized multiplier matrices have been found, the colour sampler 105 may then be hard coded with these matrices and is then ready for sampling by a user. The multiplier matrices may be stored in the memory of the sampling interface 200 or in the database 125 and requires no input from the end user. In operation, the input integers (i.e. the results of the grey-scale correction) are processed in a similar way in that they are first multiplied by the multiplier matrices, then a summation is taken across each to produce the output values. These values are colour corrected and ready to be processed at the next processing stage which is colour matching 520.

The colour matching stage 520 takes the values from the output of the colour correction stage 515, and converts these values into multiple formats which may be recognised by the end-user. These formats may include RGB, sRGB, Adobe RGB, and any other RGB representations, HSL, HSV, Hex, HSI HLS, L*a*b*, TSL and CMYK formats.

The present invention is also designed to match the sampled colour to the existing database of colours such as those of Pantone™, Sherwin-Williams™ and Dulux™ for example. The existing database of colour may be accessed by the colour sampler 105 via a communications network 115 which accesses a server 120 and database 125 or the databases of colour may be stored on the colour sampler 105 itself.

The matching of colours to existing databases of colour assists the end-user in using the colour sampler 105 in practice (i.e. such as going to their local paint shop and asking for a particular proprietary colour). In order to achieve this, the present invention compares the underlying colour value of the sample to colour values in existing database and calculates the colour distance between the two values which may be performed in an L2 norm in Cartesian space through trigonometric manipulations. Colours in the database which exhibit the minimum colour distance between the two are then identified as the nearest matching colours.

This information is output to a communications unit 525 which serves as a hub for exchange and display of information to the user. The communications unit 525 may wirelessly send and receive data to and from an external device such as a computer or smart phone which is either attached to the colour sampler 105 or forms part of the colour sampler 105. The present invention may synchronise with a smart phone to display the matched colours on the smart phone screen via an application. The communications unit may also download the colour databases from a phone or computer via a communications network 115 such as the internet. Storage on the communication unit may provide the ability for the device to be used when it is not paired with an external device such as a smart phone.

Future patent applications may be filed in Australia or overseas on the basis of or claiming priority from the present application. It is to be understood that the following provisional claims are provided by way of example only, and are not intended to limit the scope of what may be claimed in any such future application, features may be added to or omitted from the provisional claims at a later date so as to further define or re-define the invention or inventions.

The claims defining the invention are as follows:

1. A method of performing colour identification of a surface sample using light that has interacted with the surface sample, the method including the steps of:
(a) Receiving data from one or more light detectors relating to the surface sample;
(b) normalising the data against one or more predetermined greyscale calibration points, thereby determining the light intensity; and
(c) normalising the data against a predetermined set of colour calibration points so as to provide colour corrected values.

2. The method of claim 1, wherein step (c) includes performing a matrix manipulation on the data and on a predetermined set of calibration data points so as to provide colour corrected values.

3. The method of claim 1, wherein at step (b), one or more predetermined greyscale calibration points are provided, the calibration points each representing surfaces of varying intensity such that their data values may be interpolated/extrapolated into a straight line.

4. The method of claim 3, wherein the light intensity values determined at step (b) are adjusted based on an ambient temperature measurement.

5. The method of claim 1, wherein the matrix manipulation includes:
(i) receiving the measured values of each colour;
(ii) multiplying the measured values of each colour by values contained within one or more multiplier matrices; and
(iii) summing the multiplier matrices to produce a corrected colour value.

6. The method of claim 1, wherein the method further includes the step of (d) converting the colour corrected values into one or more colour formats.

7. The method of claim 6, wherein at step (d) the colour format may include RGB, sRGB, Adobe RGB, and any other RGB representations, HSL, HSV, Hex, HSI, HLS, L*a*b*, TSL and CMYK formats.

8. The method of claim 1, wherein the method further includes the step of (e) comparing and matching the converting the colour corrected values with one or more colour databases.

9. The method of claim 8, wherein a comparison carried out between an underlying L*a*b* value of the sampled colour to the corresponding L*a*b* value of each colour stored in one or more databases.

10. The method of claim 8, further including the step of calculating the colour-distance between the colours.

11. The method of claim 10, further including selecting the minimum colour distance between the colours thereby determining the nearest matching colour to the sample.

12. The method of claim 1, further including the step of (f) communicating the matching colour to a device.

13. A system for colour sampling, the system including:
a light source for illuminating a sample;
a light detector operable to detect light that has illuminated the sample so as to obtain one or more measurements of the light; and
a processor operable to receive and process the one or more measurements of the light so as to provide a spectral characteristic of the sample based on the measurements and determine the colour of the sample.

14. The system of claim 13, wherein the light source includes one or more LEDs and the light detector includes one or more photodiodes.

15. The system of claim 14, wherein the LEDs and photodiodes are tri-colour.

16. The system of claim 13, wherein the processor is further operable to normalise the photodiode values against one or more calibration points.

17. The system of claim 13, wherein the processor is further operable to perform colour correction of the photodiode values against one or more calibration data points.

18. A light sampling apparatus including:
an integrating sphere having at least one port;
a colour sensing module disposed within the integrating sphere, the colour sensing module including at least one light source and at least one light detector; and
a baffle positioned between the colour sensing module and the at least one port.

19. The apparatus of claim 18, wherein the colour sensing module includes a front face having a first light detector which faces the baffle and a rear face having a second light detector which faces away from the baffle.

20. The apparatus of claim 18, wherein the colour sensing module includes a thermometer.

21. The apparatus of claim 18, wherein the baffle further includes a waveguide there through.
